(19) United States
(12) Patent Application Publication
(10) Pub. No.: US 2015/0262263 A1
(43) Pub. Date: Sep. 17, 2015

(54) Business method permitting a charity to monetize its followers at a social networking site by permitting these followers to easily donate in response to solicitation messages

(71) Applicant: Alejandro Bellini, San Diego, CA (US)

(72) Inventor: Alejandro Bellini, San Diego, CA (US)

(21) Appl. No.: 13/999,632

(22) Filed: Mar. 13, 2014

(51) Int. Cl. G06Q 30/02; G06Q 50/00

(52) U.S. Cl. CPC G06Q 30/0279; G06Q 50/01

(57) ABSTRACT

A CHARITY uses a new web service arbitrarily called “FUNDPAL” interactively with an existing social networking organization and service, for example TWITTER”; and a web payment organization and service, for example PAYPAL; to raise money from its followers on TWITTER. After registering with TWITTER, with PAYPAL, and also with FUNDPAL to which it accords authority to send messages to its followers on its behalf, the CHARITY sends timely and topical messages (“tweets”) to its typically many followers, communicating that earmarked donations can be made to the charity. To those responding—“re-tweeting”—that they wish to donate, the charity eventually provides a hyperlink to FUNDPAL acting as its agent. This commences a process where agent FUNDPAL—recognizing that it has been mentioned in a message (“tweet”) of the CHARITY at the social networking site (TWITTER)—responds to any forwarded messages (“tweets”) from followers of the charity by facilitating their immediate charitable donations through PAYPAL. The entire process unwinds so quickly that charitable donations targeted on relief for a specific disaster may literally be made while the disaster is still unfolding.

### BACKGROUND OF THE INVENTION

1. Field of the Invention

The present invention generally concerns a business method, performed by and with aid of an agent, for a charity to monetize its followers at a social networking site.

The present invention particularly concerns a business method, performed by and with aid of an agent, by which a charity may make it quick and easy for its followers upon a social networking site to make donations to the charity in response to solicitation messages—which messages may be timely and/or topical—sent to these followers upon the social networking site.

2. Background of the Invention

### 2.1 Monetizing the Value of Its Followers Upon a Social Network by a Charity

Identically as is contemplated in U.S. patent applications publication numbers 20130204779 for MONETIZING A SOCIAL NETWORKING WEBSITE and 20120245987 for a SYSTEM AND METHOD FOR PROCESSING GIFT CARDS VIA SOCIAL NETWORKS, both to Yorgos Dionysus Marinakis, et al. (hereinafter discussed), the “embodiments of the present invention satisfy the needs of monetizing a social network website, in particular how to monetize a technology within a social network website.” The present invention will particularly be seen to teach how a charity may monetize the value of its followers upon a social network, and particularly upon the Twitter social network.

Marinakis, et al., note that “[i]nformation relevant to attempts to address these problems [or monetizing the value of a social network website] can be found in U.S. Pat. Nos. 8,296,192; 8,296,189; 8,281,233; 8,260,687; 8,103,553; 8,065,193; 8,024,317; 8,055,552; 8,090,666; 7,971,155; 7,620,636; 5,960,411; and U.S. Patent Application No.'s 20120209677; 20110066506; 20100332330; 20090222322; 20090210291; which are not admitted to be prior art with respect to the present invention by their mention in this Background Section. However, it is desirable to have a better method, system and device than is disclosed in these references.

As is further recognized by Marginalis, et al: “At present [i.e., circa 2012, 2013], all strategies for monetizing social networks depend on selling advertisement placements. The ads are usually selected based on either the profile data provided by the participant; or based on the text being entered by the participant in a status update, comment to a graphic, in a Tweet, etc. The advertiser hopes that the targeted advertisement will have a higher rate of success than a randomly placed mass market advertisement. Facebook for example reportedly has $4 B in annual revenue and with reportedly 800 million users (Wall Street Journal, Nov. 29, 2011, “Facebook targets huge IPO”), that adds up to an average of only $5 revenue per user per year. Twitter reportedly expected up to $150 m in revenues in 2011 (Bloomberg Businessweek, Jan. 24, 2011, “Twitters ad revenue may triple to $150 million, telemarketer says”). With more than 200M registered users annually (Wall Street Journal, Feb. 10, 2011, “Twitters suitors talk in billions”) and 200M tweets daily (Twitter blog, Jun. 30, 2011), that adds up to $0.75 revenue per user per year, or $0.002 per tweet. Clearly there are opportunities to further monetize social networks and the technologies in them.

“As social networks “go public,” the pressures to monetize will increase. The . . . Facebook application for IPO is a case in point. In a Feb. 3, 2012, Wall Street Journal article entitled “Facebook and Zynga: Sharing Riches Isn't Always Easy,” it is noted that 12% of Facebook's revenues come from Zynga, and that doesn't count revenues for placing ads on pages generated by Zynga's games. This dependence disturbed some investors. “If you're Facebook, you can't bank on 12% of your revenues coming from a single source.” According to its IPO filing, Facebook derived 85% of its 2011 revenue from online advertising. Moreover, as social network websites proliferate and cannibalize each other, their individual revenues will come under increased competitive pressure and they will need to find other ways besides advertising to maintain and grow revenues. “The world can absorb more social media networks, but how many? In addition, nearly all rely on advertising (including searches of their privately controlled or “walled” content) for revenue. Advertisers want to see volume and results. Because of the power of network effects and positive feedback, a relatively small number of sites will probably draw most of the user traffic and advertising dollars. So a large number of social networking businesses cannot survive with a traditional advertising business model, unless they are non-profit or no-profit. Of greater concern from the business point of view is that advertisers on social media sites such as Facebook get poor responses—about one-fiftieth the click-through rates compared to what Google sees for its sponsored ads along with Internet searches” (Michael A. Cusumano, April 2011, Technology Strategy and Management: Platform Wars Come to Social Media. COMMUNICATIONS OF THE ACM 54 (4): 31-33). Thus, current versions of social network websites may remain free to use, but next-generation versions may not.

“Another issue that may eventually reduce the precision targeting of advertisements, and therefore reduce revenues, is the public and regulatory backlash against using people's data to aggressively monetize the social network. Under a recent Federal Trade Commission order, Facebook is required to undergo an external audit of its privacy policies every two years. This, because it had been making information public that it had pledged to keep private (Babbage, Nov. 29, 2011, The Economist, Facebook and Privacy: walking the tightrope). Similar action can be expected from the European Union: “” (Cassandra, Dec. 8, 2011, The Economist, Regulators and social media: The EU prepares to poke Facebook).

“One common suggestion for monetizing social networks is the paid subscription model. In this approach, users would pay a fee to use the site, possibly on a sliding scale based on their number of connections, text postings, message sent, and photos and videos posted; or possibly simply for access.

“One form of interaction on or participation in a social network website is “messaging,” but there are other forms of interaction or participation that involve: “posting status updates” and/or “tweeting” and/or “Reply” tweeting with or without accompanying electronic files; “posting comments” on uploaded electronic files such as digital photographs and videos, where the comments are displayed in a stack in temporal order; and endorsing a comment, an uploaded file (e.g., digital photograph), an html hyperlink, an identity on a social network, etc. An “identity on a social network” is an individual or organization for which there exists a web page on that social network. These are also called user profiles. Each social network provides its own way to perform endorsements, that is, endorse a comment, file, html hyperlink, identity, or something else, on that social network. On Facebook, you “Like” an identity. On Twitter you “Follow” an identity. On Google+you “+1” an identity. Google will soon allow you to “Share” (patent application 20100332330). On Twitter you can “Re-tweet” a post, which has the effect of endorsing the post. These examples are not intended to limit the present invention. It should be possible, for example, to comment on or endorse someone else's endorsement. The “Like” button (and other endorsement mechanisms, such as Follow and Re-tweet, and +1) meets an unmet need of advertisers; namely, it provides advertisers with feedback from consumers regarding which advertisements are effective (Andy Kessler, Feb. 2, 2012, “The Button that Made Facebook Billions,” Wall Street Journal). The “like” button also provides increased opportunities for interaction between participants in the social network website.

“The embodiments of the . . . [Marginalis, et al.] invention disclose a method for monetizing a social network, which method does not depend on advertising revenues or subscription fees. Rather, the present method utilizes a transaction-based fee schedule . . . [Marginalis, et al.] call it “pay-to-participate.” The user or participant pays by the comment, status update, uploaded file, or endorsement. This is the opposite of current trends, which is where corporations and organizations pay people to post comments and files on social networks and blogs; and as discussed above, trends to the opposite of the practice of relying mainly on advertising for revenues. Facebook's recent big revenue innovation, for example, is a form of advertising they call “Sponsored Stories”: regular News Feed stories that have been promoted to the right column of Facebook, where you may be more likely to discover new things that your friends are interested in. These stories only show up for friends, so you can learn about places to go, apps to use, games to play and organizations your friends like” (http://www.facebook.com/ads/stories/). Google's “Share” button, disclosed in their patent application 20100332330, is apparently their response to Facebook's “Like” button. This button also based on advertising, and it contains the additional innovation of giving a portion of revenue generated by sharing to the people doing the sharing.

“U.S. Pat. Nos. 8,065,193; 8,103,553; 8,296,189 and 8,296,192 cover the situation where you are one of dozens or hundreds of people commenting on a blog or news post, and you want to make your comment stand out. The patent discloses the idea of allowing you to “to alter a comment from the default format to a distinctive format for a predetermined fee,” that is, make it bold and in a bigger font. In the 2009 article “Would you pay to comment on a news site?” <http://editdesk.wordpress.com/2009/03/30/comments-pay/>, it is mentioned that “John Robinson of the News & Record in Greensboro, N.C.” “floated the idea” of charging to comment on news posts. Similarly, in 2010, the Sun Chronicle of Massachusetts, in order to “encourage intelligent and meaningful conversation,” required participants to register with their full name, address, phone number, email and credit card number; and required them to verify their identity by using their credit card to pay a one-time fee of $0.99 to activate their accounts (http://www.readwriteweb.com/archives/newspaper wants readers to pay to comment.php).

“Blogs and news websites, however, are a different Art than social network websites. “Social media networks are, in different degrees, new kinds of platforms that facilitate communication and offer new systems for texting and sending email as well as sharing files. They enable computing through access to different applications and databases” (Michael A. Cusumano. April 2011. Technology Strategy and Management: Platform Wars Come to Social Media. COMMUNICATIONS OF THE ACM 54 (4): 31-33). Blogs and news websites are two-sided platforms (Eisenmann, T., Parker, G. and van Alstyne, M. W. 2006. Strategies for two-sided markets. Harvard Business Review October: 92-101.). Social networking websites for the purposes of this patent are one-sided platforms. Social networking websites are two-sided platforms in the context of games and other third-party content providers, but the present application is limited to interactions between users. On a one-sided platform or in a one-sided market, such as a stock exchange, participants play different roles at different times, e.g., sometimes a buyer, sometimes a seller. In two-sided platforms and markets, participants always play their same roles, e.g., you're always a blogger or you're always a reader. The business differences between the two types of networks are substantial. One-sided platforms can demonstrate direct network effects, but two-sided platforms can demonstrate direct and indirect network effects. Indirect network effects pose a unique set of problems to two-sided markets that are not demonstrated by one-sided markets, such as the chicken-and-egg paradox (e.g., which comes first, software availability or hardware sales?).

“U.S. Pat. No. 7,620,636 claims a method in which users can post a comment about a user or to a blog if they donate money to a charity. By definition it is not a method for monetizing a social network by social network provider; it is a method for raising money for charity. Neither does it contemplate charging a fee to upload a file to the social network. ”

### 2.2 The Use of “Widgets”, or Programs, to Monetize Social Network Value

The present invention will seen not to require any special “widget”, or program, to monetize the value of the followers of a charity upon a social network. However, it is useful to understand such “widgets”, or programs, in order to understand the basis, and the special basis, by which a charity might raise money on a social network.

U.S. Pat. No. 7,565,332, to Williams , et al. for a METHOD AND SYSTEM FOR PROVIDING A WIDGET USABLE IN AFFILIATE MARKETING describes a system and computer implemented method for providing a widget. The method and system include rendering the widget on a site. The widget dynamically displays multimedia content associated with a campaign. The widget is also embeddable, copyable, and allows for at least one user action. The method and system also include receiving at least one input related to the at least one action and updating the widget based on a goal corresponding to the at least one action.

In the system “an organizer such as a particular cause or charity may desire to use the system for events such as a fundraising campaign based only on Internet contributions, blograising performed in conjunction with a traditional (non-Internet based) fundraising campaign, campaigns that drive and track traffic to a particular Web site, campaigns that drive and track visitor actions, campaigns based on the occurrence of a particular event such as an ongoing fundraising campaign, in a campaign of limited duration, or for other purposes.” Further “when visiting . . . [a] site . . . , a user may view the content on the widget . . . and may use the widget . . . to perform various tasks. The user actions performed may be varied. Examples of such user actions includes click throughs to other site(s) associated with the campaign(s), a contribution that may be to a charity associated with the campaign(s) . . . . ”

U.S. Pat. No. 8,103,553 to Bullock for a METHOD FOR MAKING MONEY ON INTERNET NEWS SITES AND BLOGS describes a method for making an online posted comment more conspicuous relative to other online posted comments. The method can include the steps of publishing internet content online by an internet content provider; providing with the published content a section for recording and posting reader comments; viewing by a reader the published internet content; providing to the reader an option of posting for free a default format comment or posting for a fee a comment made distinctive relative to a default format comment; recording, by the reader, a comment; paying, by the reader, the fee for making the comment distinctive relative to a default format comment; and posting the reader's distinctive comment in the comment section, wherein the posted comment lacks an indication of the time of posting. The fee for distinctiveness transaction can also be implemented by use of an online auction.”

U.S. Pat. No. 8,296,189 also to Bullock for a METHOD FOR MONETIZING INTERNET NEWS SITES AND BLOGS describes a computer-implemented system for monetizing internet content, the computer comprising a processor for executing computer executable instructions. The system includes an internet content provider providing by the computer executable instructions online information and an online comment section associated with the online information. The online comment section is capable of having posted thereto reader comments in a free default format or a fee-paid distinctive format.

In each of the Bullock patents it is described that “For many financial transactions, such as payment for making a comment distinctive on an internet content provider's comment section, or downloading music, or contributing to charity, the amount to be paid can be relatively small, such as $1.99.”

### 2.3 Many Recent U.S. Patent Applications Concern Raising Money on the World Wide Web

Many recent U.S. patent applications concern raising money on the World Wide Web. For example, U.S. publication numbers 20140052617 for a PAYMENT PLATFORM INTERFACE WIDGET GENERATION APPARATUSES, METHODS AND SYSTEMS; 20140032371 for SYSTEMS AND METHODS OF PROCESSING INFORMATION AND TRANSACTIONS INVOLVING DIGITAL CONTENT AND/OR EXPERIENCES ASSOCIATED WITH CELEBRITIES AND NETWORKED USERS; 20130346302 for REMOTE PORTAL BILL PAYMENT PLATFORM APPARATUSES, METHODS AND SYSTEMS; and 20130325621 for an APPARATUS, SYSTEM AND METHOD OF PROVIDING DEDICATED MOBILE APPS FOR USE BY CELEBRITIES all concern method suitable of use by charities to raise money.

U.S. Publications numbers 20130318005, 20130318004, 20130317978, and 20130317966 all for APPARATUSES, METHODS AND SYSTEMS FOR FACILITATING COMMUNITIES OF SOCIAL NETWORK BASED INVESTMENT; U. S. Publication number 20130290203 for SOCIAL CHECKOUT WIDGET GENERATION AND INTEGRATION APPARATUSES, METHODS AND SYSTEMS; U. S. Publication number 20130282454 VIRTUAL ENVIRONMENT WITH TARGETED ADVERTISING AND REWARDS; U.S. Publication number 20130204779 MONETIZING A SOCIAL NETWORKING WEBSITE; U.S. Publication number 20130159117 for an APPARATUS, SYSTEM AND METHOD OF PROVIDING DEDICATED MOBILE APPS FOR USE BY CELEBRITIES; U.S. Publication number 2013009099 for a SOCIAL PLATFORM E-COMMERCE SYSTEM AND METHOD OF OPERATION; U.S. Publication number 20120284649 for a SYSTEM FOR RECORDING AND BROADCASTING AUDIO MESSAGES TO SOCIAL NETWORKS, WEB, BLOG SPACES AND QUICK RESPONSE CODES; U.S. Publication number 20120245987 for a SYSTEM AND METHOD FOR PROCESSING GIFT CARDS VIA SOCIAL NETWORKS; U.S. Publication number 20120069131 for REALITY ALTERNATE; and U.S. Publication number 2011027642 for SYSTEMS AND METHODS FOR CONTENT COMMUNICATION all also concern method suitable of use by charities to raise money.

Commensurate with the recently increased importance of social networking on the Internet, fewer patents have actually issued than applications are pending circa 2014, Among the issued patents are the aforementioned United States Patent Application number 20130204779 to Yorgos Dionysus Marginalis for MONETIZING A SOCIAL NETWORKING WEBSITE. This Marginalis patent describes a method enabling social networking website providers to monetize a social networking website, comprising charging users for posting content per posting action. A social networking website graphical user interface component comprising an indicator, wherein a user's indicator displays a balance of funds in an account held by the user on the social networking website, wherein the user's indicator decrements proportionately whenever the user's account is debited, wherein the user's indicator increments proportionately whenever the user's account is credited.

The Mirinakis patent recognizes, as does the present invention, that “[a] user of a social network website creates and maintains a profile. An organization such as a charity or a for-profit corporation can create a profile and be a user.”

In the Mirinakis patent application “embodiments of the . . . invention can be used by charities to solicit donations. Namely, a charity can display the indicator on its profile in a social network website, and use the indicator to solicit comments for which it receives a portion of the fees.”

### 2.4 Social Networking Websites

As stated in Wikipedia (http://en.wikipedia.org/wiki/Social networking service) circa 2014, “A social networking service [i.e., website] is an online service, platform, or site that focuses on building and reflecting of social networks or social relations among people, who, for example, share interests and/or activities. A social network service consists of a representation of each user (often a profile), his/her social links, and a variety of additional services. Most social network services are web-based and provide means for users to interact over the Internet, such as e-mail and instant messaging. Online community services are sometimes considered as a social network service, though in a broader sense, social network service usually means an individual-centered service whereas online community services are group-centered. Social networking sites allow users to share ideas, activities, events, and interests within their individual networks. It is also used in today's modern times to meet new people and form relationships such as dating.”

“The main types of social networking services are those that contain category places (such as former school year or classmates), means to connect with friends (usually with self-description pages), and a recommendation system linked to trust. Popular methods now combine many of these, with Facebook and Twitter widely used worldwide, The Sphere (luxury network), Nexopia (mostly in Canada); Bebo, VKontakte, Hi5, Hyves (mostly in The Netherlands), Draugiem.lv (mostly in Latvia), StudiVZ(mostly in Germany), iWiW (mostly in Hungary), Tuenti (mostly in Spain), Nasza-Klasa (mostly in Poland), Decayenne, Tagged, XING, Badoo and Skyrock in parts of Europe; Orkut and Hi5 in South America and Central America; and Mixi, Multiply, Orkut, Wretch, renren and Cyworld in Asia and the Pacific Islands and Facebook, Twitter, Linkedln and Google+are very popular in India and Pakistan.”

A user of a social network website creates and maintains a profile. An organization such as a charity or a for-profit corporation can create a profile and be a user.

Each social network provides its own way to perform endorsements, that is, endorse a comment, file, html hyperlink, identity, or something else, on that social network. On Facebook®, you “Like” an identity. On Twitter® you “Follow” an identity. On Google+® you “+1” an identity. On Twitter you can “Re-tweet” a post, which has the effect of endorsing the post. These examples are not intended to limit the present invention.

Over 20 charities have over 2M Twitter followers each.

### SUMMARY OF THE INVENTION

The present invention contemplates a business method that satisfies the needs set out in the Background section, to wit: a computer-implemented business method enabling a charity to monetize the value of its followers upon a social networking website.

The present invention is embodied in a business method performed by an agent communicatively interactive upon a worldwide communications network interactively with (1) a charity broadcasting at a social networking site, (2) a funds transfer agent, and (3) people following the charity at the social networking site and wishing to make donations to the charity, all upon the worldwide communications network to the end that the charity may expeditiously receive said donations.

The method commences when (1) the agent enrolls at a social networking site so that it may send messages upon the social networking site as permitted by the social networking site; (2) the charity registers with the social networking site so that it may accumulate followers to which it can send messages as permitted by the social networking site; (3) the charity registers with the agent through the social networking site, giving the agent, enrolled at the social networking site, permission to send messages to followers of the charity upon the social networking site; and (4) the charity also registers with the funds transfer agent, giving the charity a capacity to receive monies through the funds transfer agent. These preparatory steps may occur in any order.

Then, during course of messaging it's followers upon the social networking site, the charity communicates that donations can be made to the charity by forwarding the message to the agent. This commences a process at the agent where the agent, as a follower of the charity at the social networking site, recognizes that it has been mentioned in a message of the charity at the social networking site; and, subsequent to this message. The agent receives further forwarded copies of the message of the charity from followers of the charity wishing to donate to the charity in response to the message of the charity. The agent communicates back to all followers of the charity so communicating a wish to donate upon the same social networking site, as it is permitted by the charity to do, and instructs each of these followers so communicating a link to the funds transfer agent at which link the follower may donate to the charity. The follower wishing to donate to the charity follows the link to the funds transfer agent and does so donate, registering his/her donation as a credit at his/her account at the funds transfer agent, and as a debit to the account of the charity at the funds transfer agent.

The agent typically earns a small fee from the charity for donations actually made by followers of the charity referred to the funds transfer agent. Likewise, the funds transfer agent typically earns a small fee from the charity for donations actually made by followers of the charity to the charity through the funds transfer agent.

The charity knows from its statement received from the funds transfer agent who among its followers at the social networking site did donate in response to its message there. The charity further knows from its statement received from the funds transfer agent what message a follower at the social networking site who did donate did respond to.

Preferably when the agent received a further forwarded copies of the message of the charity from a follower of the charity wishing to donate to the charity in response to the message of the charity, then so also did the followers of this follower of the charity receive notice of this forwarded message, encouraging and inspiring them to likewise seek to donate to the charity.

The social networking site is most preferably Twitter; the message communicated by the charity upon the social networking site is a tweet, and the forwarded message communicated by the follower of charity upon the social networking site is a re-tweet.

The funds transfer agent is preferably Paypal.

These and other aspects and attributes of the present invention will become increasingly clear upon reference to the following drawings and accompanying specification.

### BRIEF DESCRIPTION OF THE DRAWINGS

FIG. 1 is a flow chart of a preferred embodiment of the method of the present invention particularly from the viewpoint of the charity participating in the method.

FIG. 2 is a flow chart of the same preferred embodiment of the method of the present invention previously seen in FIG. 1 now particularly from the viewpoint of the donor participating in the method.

### DESCRIPTION OF THE PREFERRED EMBODIMENT

The present invention contemplates a new service arbitrarily called “FUNDPAL” arbitrarily resident on the web at, by way of example, “fundpal.org”. FUNDPAL performs the method of the present invention next described interactively with an existing (1) social networking organization and service, for example Twitter at twitter.com [hereinafter called “TWITTER”]; (2) a web payment organization and service, for example Paypal at paypal.com, [hereinafter called “PAYPAL”], and (3) one or more arbitrary charities each at its own website, [hereinafter arbitrarily to be designated by an exemplary one such charity to be called “CHARITY”]. The purpose of FUNPAL, and of FUNPAL's performance of the method of the present invention is (1) to raise money for the CHARITY by donations to the CHARITY, with (2) some, generally small, transaction fees deducted for said donations, and earned by, both PAYPAL and FUNPAL.

The reasons why the CHARITY might wish to permit, facilitate and encourage that if should receive donations via a route through FUNPAL and PAYPAL—who both deduct (modest) fees—is that the charity should expeditiously receive donations via this route that it might otherwise never have received at all. A primary reason for believing that the CHARITY is so getting donations via this route that might otherwise not be scavenged is data regarding charitable giving relative to the times of disasters reported on the news, and particularly those disaster in which the charity immediately timely announces that it is, or intends to, participate in charitable relief. Interviews with Americans after disasters both domestic and foreign indicate that many are interested in making charitable donations for disaster relief, but are frustrated that these donations may be both (1) delayed, and (2) obscured as to precise purpose, when given through normal charitable giving channels. The method of the present invention will prove to be particularly excellent in proving that—a charity having tweeted to its followers about its ongoing or proposed response to an incipient disaster within mere minutes, hours or days of the onset of such disaster—the charity can received donations—focused by the donor if desired on a particular incipient disaster—within mere within minutes, hours or days of the onset of such disaster . Based on past patterns of charitable giving, it is not unreasonable to believe that a major charity such as, by way of example, the American Red Cross, could raise tens and hundreds of millions of dollars within mere hours of a major disaster, such as 911.

Moreover, the present invention will be found not only to provide that charitable donations may be both (1) public, and (2) associated with a certain event, or cause, but (3) the followers (upon a social network) of the donor are substantially instantly notified of the donation. It may thus become “trendy” to make a fast and incisive charitable donation in response to a particular breaking event and, indeed, it becomes possible that followers of a donor should first learn of the event from report of the donation! For example, it is not unreasonable for a large national charitable organization, such as the Red Cross, to put out a blanket announcement (a “tweet” in the most preferred embodiment of the invention) some minutes into an unfolding event to the effect that “The Red Cross is dispatching emergency response teams and resources to provide all possible assistance to victims of the tragedy now unfolding in lower Manhattan this 11^{th} of September, 2001. Send your donations earmarked for this relief to [link]”. In such an environment it is expected that the method of the present invention could have facilitated the (1) making, (2) acknowledging, (3) recording, and (4) publicizing of donations (to the Red Cross) even before the first World Trade Tower fell. Such is the potential speed of our modern digital age. Not only are charitable donations scavenged while the initial impulse to donate is “hot”, but it may become an actual race between donors, and especially those with special interests like air disasters, to show up both (1) early, and (2) with large donations, so as to inspire others to donate.

1. The Flow Chart and the Experience of the Preferred Method of the Present Invention from the Perspective of the Charity

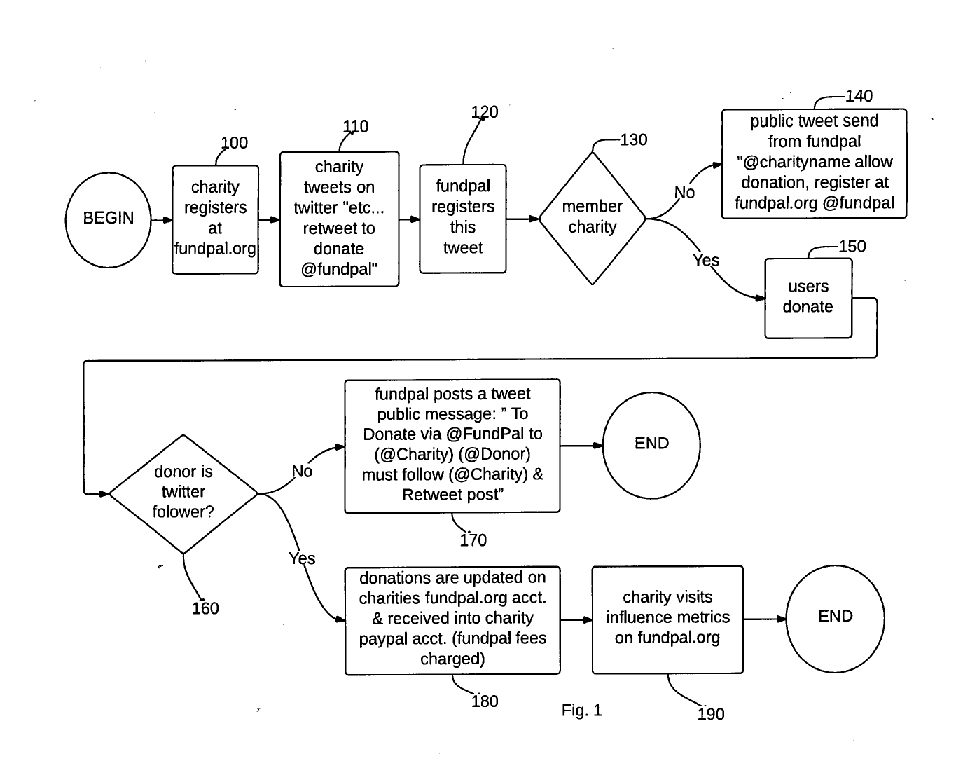

A flow chart of a preferred embodiment of the method of the present invention—particularly from the viewpoint of the charity participating in the method—is shown in FIG. 1. In performance of the preferred method of the present invention, CHARITY registers at FUNDPAL located at fundpal.org, as shown in block 100. The CHARITY must sign in through TWITTER, thus giving FUNDPAL permission to send direct messages, or tweets, to the followers of the CHARITY on behalf of the CHARITY. During registration at FUNDPAL (block 110) the CHARITY must also confirm that it has a PAYPAL account of accounts to receive payments, and must provide the identification of each such PAYPAL account at which it does then, or in the future prospectively may, wish to receive payments. The CHARITY must know, and must aver to FUNDPAL that it knows and understands how to use PAYPAL.

Thereafter, the CHARITY then goes as and when desired to its TWITTER account and tweet “etc . . . etc . . . , re-tweet to donate @FUNDPAL” (block 140). This is broadcast to their every TWITTER follower of the CHARITY, as well as whoever looks the CHARITY up at TWITTER. FUNDPAL server computers recognize that it has been mentioned in a tweet, determines whether or not the CHARITY is registered already (if not, FUNDPAL publicly tweets “Dear CHARITY; To use @FUNDPAL, please first register at FUNDPAL.org”). However, if CHARITY has registered, then FUNDPAL awaits the next step

A TWITTER follower of the CHARITY (hereinafter called “JOHN”) sees the tweet on TWITTER

If he wishes to bring attention to the tweet, JOHN re-tweets it (block 150). FUNDPAL knows to begin an automated process from here forward

FUNDPAL first checks to see if JOHN is a TWITTER follower of CHARITY A. IF not, then FUNDPAL tweets publically, “@John, in order to donate to @CHARITY A through @FUNDPAL, please first follow @CHARITY then re-tweet”. IF, however, JOHN is already a TWITTER follower of the CHARITY, then FUNDPAL sends a direct message to JOHN via TWITTER as has been permitted by CHARITY (block 170). (Remember in step 1 that CHARITY permitted via the TWITTER API that FUNPAL should send direct messages to the TWITTER followers of the CHARITY on behalf of the CHARITY.)

JOHN opens the direct message on TWITTER from CHARITY and discovers the following text and a tiny URL (unique to the transaction): “Thank you for your pledge! Follow this link to donate.

If JOHN doesn't follow the link, the process ends.

If JOHN does follow the link, then the following occurs.

JOHN clicks on the tinyurl & his mobile browser (if he is on mobile device) brings up his unique donation page. If it's his (i.e., JOHN's) first time using FUNDPAL, then he is asked to sign in via TWITTER, enter PAYPAL account & password—or—enter credit card number & billing information and an amount to donate, and accept the terms of service (TOS) and remember me. IF JOHN has used the FUNDPAL service BEFORE, then FUNDPAL remembers him and JOHN simply needs to enter the dollar amount to donate and accept to make the donation (block 180).

JOHN's donation is registered on both the CHARITY “my account” section of FUNDPAL and on JOHN's “my account” section of FUNDPAL (block 190).

Both CHARITY and JOHN can use these metrics in various ways

JOHN can use the influence meter to see his direct donation, his indirect influence and the total campaign donations. NOTE: when JOHN re-tweeted the CHARITY tweet to initiate this process to donate, it was broadcast to all of his TWITTER followers as well, and so on.

In this preferred method of the present invention the payment gateway has been an adaptive payment to CHARITY through PAYPAL adaptive or a similar service. In addition to this payment gateway fee, FUNDPAL will impose additional fees per transaction. A typical fee might be, for example, $.99 per transaction plus 1.99% of transaction amount.

### 2. The DONOR-Side Experience

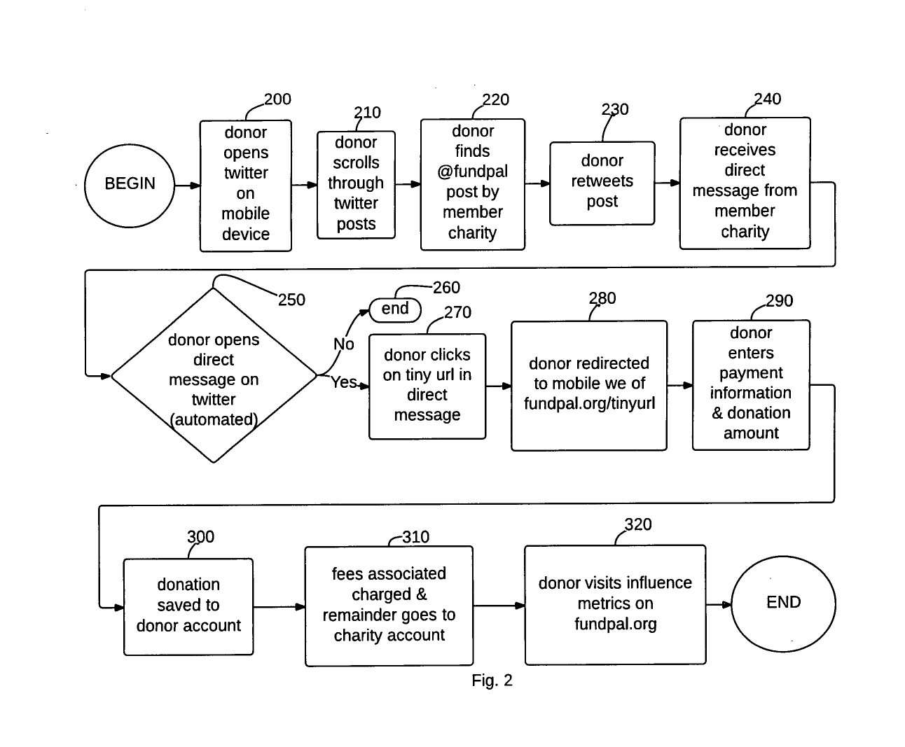

A flow chart of the same preferred embodiment of the method of the present invention previously seen in FIG. 1—now particularly from the viewpoint of the donor participating in the method—is shown in FIG. 2. The preferred user-side (donor-side) experience proceeds as follows.

The DONOR opens TWITTER on his or her smartphone or other, typically mobile, device (block 200). The DONOR sees a post from CHARITY, and wishes to respond to the entreaty for a donation (blocks 210, 220)

The DONOR re-tweets the post (block 230), as he/she is requested to do. In return the DONOR receives a direct message notification from FUNDPAL.

The DONOR opens this direct message (block 240), and follows as requested the link therein, which link is normally minimized in length in accordance with tiny UR (blocks 250, 270, 280).

The DONOR sees the donate screen from PAYPAL on his/her smartphone or other, typically mobile, device (block 280). The screen preferably shows the (1) tweet re-tweeted on top, (2) dollar amount, (3) PAYPAL login or credit card, (4) acceptance terms of service, and (5) a field to enter a donation amount. The donor makes a desired donation (block 290)

If the DONOR re-tweeting is not a follower of the charity as was identified to FUNDPAL, then the DONOR is massaged: “NOTE: You haven't followed CHARITY but have re-tweeted: To donate you must follow (@Charity) & Re-tweet . Thank you.”

The donation at Paypal is saved to the donor account, the fees of PAYPAL are charged, and the balance is remitted to the credit of the account of the charity at PAYPAL (blocks 300, 310, 320).

According to these variations, and still others within the skill of a practitioner of the arts of Internet social and financial services, the present invention should be considered in accordance with the following claims, only, and not solely on accordance with those embodiments within which the invention has been taught.

What is claimed is:

1. A business method performed by an agent communicatively interactive upon a worldwide communications network interactively with (1) a charity broadcasting at a social networking site, (2) a funds transfer agent, and (3) people following the charity at the social networking site and wishing to make donations to the charity, all upon the worldwide communications network to the end that the charity may expeditiously receive said donations, the method comprising:
the agent enrolls at a social networking site so that it may send messages upon the social networking site as permitted by the social networking site;
the charity registers with the social networking site so that it may accumulate followers to which it can send messages as permitted by the social networking site;
the charity registers with the agent through the social networking site, giving the agent, enrolled at the social networking site, permission to send messages to followers of the charity upon the social networking site;
the charity also registers with the funds transfer agent, giving the charity a capacity to receive monies through the funds transfer agent; then during course of messaging it's followers upon the social networking site, the charity communicates that donations can be made to the charity by forwarding the message to the agent; commencing a process at the agent where
the agent, as a follower of the charity at the social networking site, recognizes that it has been mentioned in a message of the charity at the social networking site; and, subsequent to this message
the agent receives further forwarded copies of the message of the charity from followers of the charity wishing to donate to the charity in response to the message of the charity;
the agent communicates back to all followers of the charity so communicating a wish to donate upon the same social networking site, as it is permitted by the charity to do, and instructs each of these followers so communicating a link to the funds transfer agent at which link the follower may donate to the charity;
the follower wishing to donate to the charity follows the link to the funds transfer agent and does so donate, registering his/her donation as a credit at his/her account at the funds transfer agent, and as a debit to the account of the charity at the funds transfer agent.

2. The method according to claim 1
wherein the agent earns a small fee from the charity for donations actually made by followers of the charity referred to the funds transfer agent.

3. The method according to claim 1
wherein the funds transfer agent earns a small fee from the charity for donations actually made by followers of the charity to the charity through the funds transfer agent.

4. The method according to claim 1
wherein the charity knows from its statement received from the funds transfer agent who among its followers at the social networking site did donate in response to its message there.

5. The method according to claim 4
wherein the charity further knows from its statement received from the funds transfer agent what message a follower at the social networking site who did donate did respond to.

6. The method according to claim 1
wherein upon when the agent did receive a further forwarded copies of the message of the charity from a follower of the charity wishing to donate to the charity in response to the message of the charity, then so also did the followers of this follower of the charity receive notice of this forwarded message, encouraging and inspiring them to likewise seek to donate to the charity.

7. The method according to claim 1 wherein the social networking site is:
Twitter; and
wherein message communicated by the charity upon the social networking site is:
a tweet; and
wherein the forwarded message communicated by the follower of charity upon the social networking site is
a re-tweet.

8. The method according to claim 1 wherein the funds transfer agent is:
Paypal.

9. The method according to claim 1 that. after the agent receives forwarded copies of the message of the charity from followers of the charity wishing to donate to the charity in response to the message of the charity and before instructing each of these followers so communicating a link to the funds transfer agent at which link the follower may donate to the charity, further comprises;
determining whether a follower of the charity wishing to donate to the charity in response to the message of the charity does have an active account with the funds transfer agent and, if not, helping this follower to so obtain an account before a donation is made.

10. A method performed by a charity to receive donations from its followers upon a social network, the method for monetizing the value to the charity of said followers of the charity upon the social network, the method comprising:
the charity registers with a Internet social networking site so that it may accumulate followers to which it can send messages as permitted by the social networking site; further
the charity registers with a third party Internet funds transfer agent, giving the charity a capacity to receive monies through funds sent to this funds transfer agent upon the Internet by persons wishing to donate to the charity, the third party Internet funds transfer agent keeping an agreed-upon fee for this service; further
the charity registers with an Internet service provider agent that is also enrolled at the social networking site as a follower of the charity, giving this agent permission to send messages to followers of the charity upon the social networking site in order to encourage, and to account for, easily-made donations to the charity, the service provider agent keeping an agreed-upon fee for this service; then
during the course of communicating messages regarding its works to voluntarily enrolled followers upon a social network, the charity solicits that followers should make a financial donation to the charity by the simple act of further transmitting a response message including to the charity from which the solicitation message arose;
receiving this response message, the charity sends a direct message to the responding follower now requesting that the follower should make this donation to the charity by the further simple act of clicking on a hyperlink to the service provider agent; whereupon
the follower so clicking on the hyperlink commences a dialog with the service provider agent in and by which the follower may, in his or her own sole discretion, continue in order to make a financial donation to the charity through the funds transfer agent; whereupon
the funds transfer agent collects on behalf of the charity a monetary donation from the user, forwarding the agreed-upon percentage of the proceeds along with others like received to the charity.

11. The method according to claim 10 wherein the social networking site is:
Twitter; and
wherein message communicated by the charity upon the social networking site is:
a tweet; and
wherein the forwarded message communicated by the follower of charity upon the social networking site is:
a re-tweet; and
wherein the funds transfer agent is:
Paypal.

12. A method by which a human user may donate to a charity via his/her smartphone comprising:
the follower opens his/her social networking account on his/her smartphone and sees a message from a charity requesting follower donation of money to the charity by simple act of replying to the message; whereupon receiving a reply
the charity sends a personal message to the replying follower, requesting the follower to follow a provided link to a third party agent of the charity to make said donation, said third party agent automatically seeing from this link that the charity has invoked its services and enrolls the charity for these services if the charity has not already done so;
the follower still desiring to donate to the charity follows as requested in the personal message from the charity the link to the third party agent, and is assisted by this agent in making a donation on behalf of the charity through a funds transfer agent with which the charity has already registered; whereupon
the third party agent has helped collects on behalf of the charity a monetary donation from the follower of the charity upon the social network.

13. A method performed by a charity to monetize persons who are voluntarily enrolled to receive messages regarding the activities of the charity on their smartphones as are enrolled upon a social network, the method comprising:
the charity registers with an Internet social networking service;
the charity registers with an Internet funds transfer service;
the charity registers with an Internet third party service provider to process on behalf or the charity monetary donations to the charity, whereupon
the charity sends messages upon a social network to the smartphone of a human user who is voluntarily enrolled as a follower of the charity upon the social network to receive these messages, at least one message requesting that a hyperlink that is within the message should be followed by the user/follower recipient of the message to donate money to the charity;
whereupon
the solicited user/follower desiring to donate follows the link and communicates with the Internet third party service provider who helps the user/follower to make a donation on behalf of the charity at the Internet funds transfer service; whereupon
the combined services of both the Internet third party service provider and the Internet funds transfer agent serve to collect on behalf of the charity a monetary donation to the charity from the user/follower of the charity upon the Internet social network.

14. The method according to claim 13 wherein the Internet social networking service is:
Twitter; and
wherein message communicated by the charity upon the Twitter Internet social networking service is:
a tweet; and
wherein the message communicated by the follower of charity upon the Twitter Internet social networking service is
a re-tweet.

15. The method according to claim 13 wherein the Internet funds transfer agent is:
Paypal.
